(19) United States
(12) Patent Application Publication
(10) Pub. No.: US 2013/0220443 A1
(43) Pub. Date: Aug. 29, 2013

(54) APPARATUS AND METHOD FOR FLOW CONTROL

(71) Applicant: THE BOARD OF TRUSTEES OF THE UNIVERSITY OF ILLINOIS, (US)

(72) Inventors: Blake J. Landry, Champaign, IL (US); Andrew R. Waratuke, Mahomet, IL (US); Yovanni A. Catano, Dorchester, MA (US); Marcelo H. Garcia, Champaign, IL (US)

(73) Assignee: THE BOARD OF TRUSTEES OF THE UNIVERSITY OF ILLINOIS, URBANA, IL (US)

(21) Appl. No.: 13/770,253

(22) Filed: Feb. 19, 2013

Related U.S. Application Data
(60) Provisional application No. 61/601,785, filed on Feb. 22, 2012.

(51) Int. Cl. F16K 47/08

(52) U.S. Cl. CPC F16K 47/08
USPC 137/315.01; 137/613

(57) ABSTRACT

A system that incorporates teachings of the present disclosure may include, for example, an apparatus including at least one first plate having at least one first opening and at least one second plate having at least one second opening. The apparatus can include a connector for coupling the at least one first plate and the at least one second plate, where the at least one first and second openings are offset to form a non-linear flow path for restricting flow of a fluid through the at least one first and second plates. Additional embodiments are disclosed.

### PRIOR APPLICATION

The present application claims the benefit of priority to U.S. Provisional Application No. 61/601,785 filed on Feb. 22, 2012, which is hereby incorporated herein by reference.

### FIELD OF THE DISCLOSURE

The present disclosure relates generally to flow systems, and more particularly to an apparatus and method for flow control.

### BACKGROUND

Flow control can be performed in a number of different ways using various devices, including valves and vortex-type restrictors. However, some of these devices are complex and costly, while others of these devices are not durable.

Conditions of the environments in which flow control is necessary can vary widely. Often times, devices that may work adequately in one environment do not perform well in another environment, particularly where there are significant differences in temperature, velocity, or pressure.

### BRIEF DESCRIPTION OF THE DRAWINGS

FIG. 1 depicts an exploded view of an illustrative embodiment of exemplary components of a restrictor assembly;

FIG. 2 depicts a cross-sectional view of the restrictor assembly of FIG. 1 when assembled;

FIG. 3 depicts a cross-sectional view an illustrative embodiment of an exemplary restrictor assembly when assembled and installed in a receiving pipe;

FIG. 4 depicts a plan view of an illustrative embodiment of a first restrictor plate of the restrictor assembly of FIG. 1 where the cross-hatched regions represent open areas for fluid flow therethrough;

FIG. 5 depicts a cross-sectional side view of the first restrictor plate of FIG. 4 taken along a diameter of the plate;

FIG. 6 depicts a plan view of an illustrative embodiment of a second restrictor plate of the restrictor assembly of FIG. 1 where the cross-hatched region represents open areas for fluid flow therethrough;

FIG. 7 depicts a cross-sectional side view of the second restrictor plate of FIG. 6 taken along a diameter of the plate;

FIG. 8 depicts a plan view of an illustrative embodiment of a support frame of the restrictor assembly of FIG. 1 where the cross-hatched regions represent open areas for fluid flow therethrough;

FIG. 9 depicts a cross-sectional side view of the support frame of FIG. 8 taken along a diameter of the frame;

FIG. 10 depicts a plan view of an illustrative embodiment of a gasket of the restrictor assembly of FIG. 1 where the center region is open;

FIG. 11 depicts a cross-sectional side view of the gasket of FIG. 10 taken along a diameter of the gasket;

FIG. 12 depicts a plan view of an illustrative embodiment of a spacing ring of the restrictor assembly of FIG. 1 where the center region is open;

FIG. 13 depicts a cross-sectional side view of the spacing ring of FIG. 12 taken along a diameter of the ring;

FIG. 14 depicts a plan view of an illustrative embodiment of a cylindrical spacer of the restrictor assembly of FIG. 1 where the center region is open;

FIG. 15 depicts a cross-sectional side view of the cylindrical spacer of FIG. 14 taken along a diameter of the spacer;

FIG. 16 depicts an illustrative embodiment of a flow system in which the restrictor assembly of FIG. 1 is installed;

FIG. 17 depicts a cross-sectional side view of another illustrative embodiment of a restrictor plate that can be utilized with the restrictor assembly of FIG. 1 where the cross-section is taken along a diameter of the plate;

FIG. 18 depicts a cross-sectional view of another illustrative embodiment of exemplary components of another restrictor assembly when assembled;

FIGS. 19-21 schematically represent another illustrative embodiment of pairs of other exemplary restrictor plates that can be used with the restrictor assembly of FIG. 1 and that can be rotated to adjust the flow characteristics through the restrictor assembly;

FIG. 22 depicts a cross-sectional view of another illustrative embodiment of exemplary components of another restrictor assembly when assembled;

FIG. 23 depicts a cross-sectional side view of another illustrative embodiment of a restrictor plate that can be utilized with the restrictor assembly of FIG. 1 where the cross-section is taken along a diameter of the plate;

FIG. 24 schematically illustrates a computational domain showing water-surface elevations and computational block locations that were utilized in gathering data for an exemplary restrictor assembly.

FIG. 25 graphically represents discharge rates associated with an exemplary restrictor assembly of FIG. 24;

FIGS. 26-27 graphically represent pressure distributions associated with the exemplary restrictor assembly of FIG. 24;

FIGS. 28-29 graphically represent velocity distributions associated with the exemplary restrictor assembly of FIG. 24;

FIGS. 30-42 depict various plan and cross-sectional views of an illustrative embodiment of exemplary components of another restrictor assembly with exemplary dimensions; and

FIG. 43 depicts an illustrative diagrammatic representation of a machine in the form of a computer system within which a set of instructions, when executed, may cause the machine to perform any one or more of the methodologies disclosed herein;.

### DETAILED DESCRIPTION

One or more of the exemplary embodiments described herein provide a flow control device and a method of flow control with modularity to enable versatility, ease of installation, ease of maintenance, and/or cost efficiency.

In one embodiment, an efficient yet simple design can be utilized that includes with a single bolt used to install the device in a pipe. In one embodiment, a compact design can be utilized to minimize the risk of damage to the device by debris entering the flow system (e.g., a sewer system having a sewer catchment), such as by positioning the unit to sit almost completely within the pipe, (e.g., extending the device about 6-inches into a sewer pipe).

In one embodiment, an integral small-diameter mesh screen can be utilized to prevent large debris from entering a restrictor portion of the device, minimizing the risk of internal clogging. In one embodiment, a modular design can be utilized to allow or otherwise enable a greater amount of flexibility. For example, the discharge characteristics of the device can be simply and inexpensively modified by adding or removing restrictor plates from a modular assembly of the device.

It should be understood by one of ordinary skill in the art that features of different embodiments, including structure(s) and/or methodology step(s), can be combined with each other and/or one or more features, including structure(s) and/or methodology step(s), can be eliminated from one or more of the various embodiments described herein.

One embodiment of the present disclosure entails an apparatus including at least one first plate having at least one first opening, at least one second plate having at least one second opening, and a connector for coupling the at least one first plate and the at least one second plate. The at least one first and second openings are offset to form a non-linear flow path for restricting flow of a fluid through the at least one first and second plates.

One embodiment of the present disclosure entails a kit capable of having at least a portion thereof assembled to form a restrictor assembly. The kit includes a support structure and a group of plates including a plurality of first plates and a plurality of second plates. Each first plate of the plurality of first plates has at least one first opening, and each second plate of the plurality of second plates has at least one second opening. The kit also includes a connector for coupling the support structure with at least one first plate of the plurality of first plates and with at least one second plate of the plurality of second plates to assemble the restrictor assembly. The at least one first opening and the at least one second opening have a size, shape and position that cause a restriction of flow of a fluid through the restrictor assembly when assembled.

One embodiment of the present disclosure entails an apparatus having a plurality of plates including a first plate and a second plate, where the first plate has at least one first opening, and where the second plate has at least one second opening. The apparatus can also include a connector for coupling the plurality of plates. The apparatus can also include a spacing structure to maintain a desired spacing between the at least one first opening and the at least one second opening when the plurality of plates is coupled by the connector. The at least one first and second openings have a size, shape and position that restrict flow of a fluid through the apparatus.

One embodiment of the present disclosure entails a method of restricting flow of a fluid. The method can include providing an assembly that has interchangeable restriction plates with one or more openings therethrough that restrict flow. The restriction plates can be interchanged, including adding or eliminating plates from the assembly and/or changing the order of the plates in the assembly, to adjust flow characteristics. In one embodiment, the orientation of the plates can be adjusted to adjust flow characteristics.

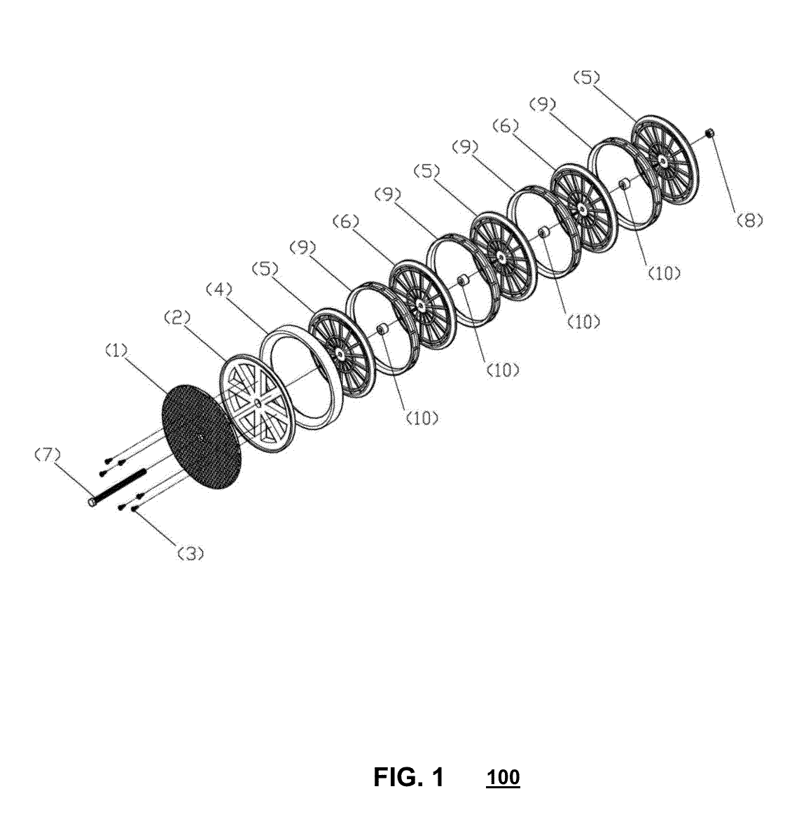

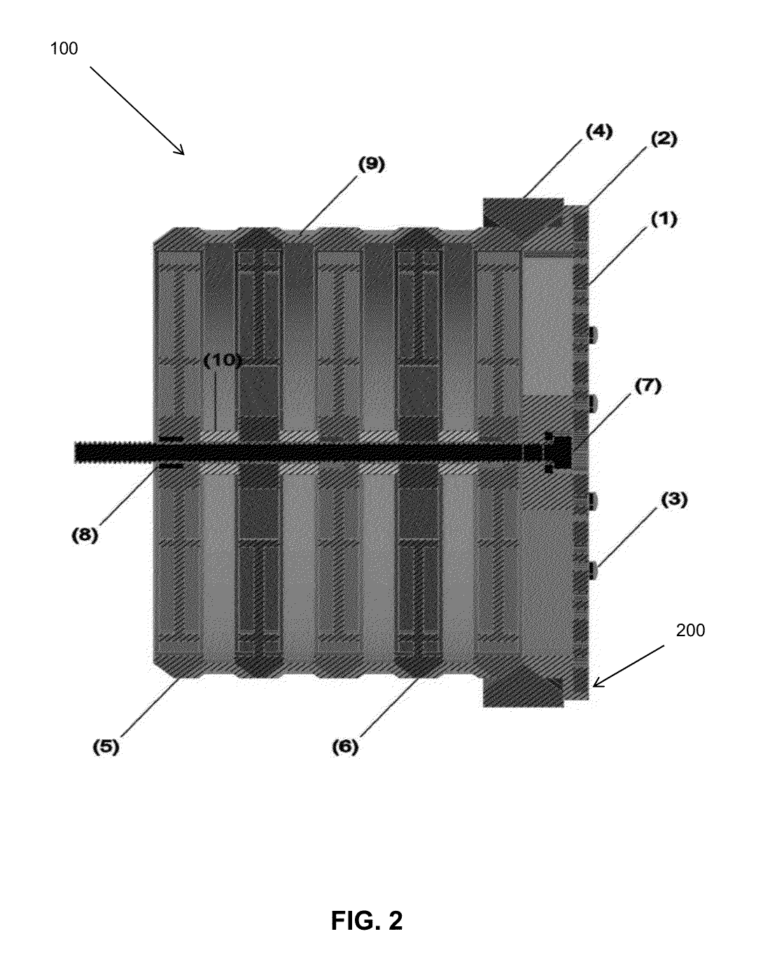

Referring to FIGS. 1 and 2, a flow restrictor assembly 100 is shown in unassembled and assembled views. The assembly can include a filter 1 mounted on a support frame 2. The filter 1 can be of various types including a perforated plate, mesh, and so forth. The filter 1 can be connected with the support frame 2, including by a direct connection, although indirect connection can also be utilized, through various techniques and/or structures, such as by way of self-tapping stainless steel screws 3. In one embodiment, the support frame 2 can include or otherwise provide a step or seat 200 along a front face of the support frame so that the filter can be disposed in the step. For example, the step 200 can have a depth that enables the filter 1 to be substantially flush with the front face of the support frame 2 (e.g., aligned within ±0.25 inches and more preferably aligned within ±0.125 inches). The filter 1 can have openings therein having a size, shape and/or configuration, as well as being formed of a material(s), which allows for screening debris of an undesired size to prevent such debris from entering the flow restrictor assembly. The particular type of filter 1, including the size, shape and/or configuration of the filter openings and the type of filter material(s) can be selected based on a number of factors, including one or more of flow velocity, pressure, temperature, types of fluid and/or debris, types of environments, cost, and so forth. In this exemplary embodiment, a single filter 1 is shown that is positioned at the entrance of the restrictor assembly 100. However, the exemplary embodiments can include other numbers and/or positions of the filters 1, including utilizing different types of filters at different locations of the restrictor assembly 100.

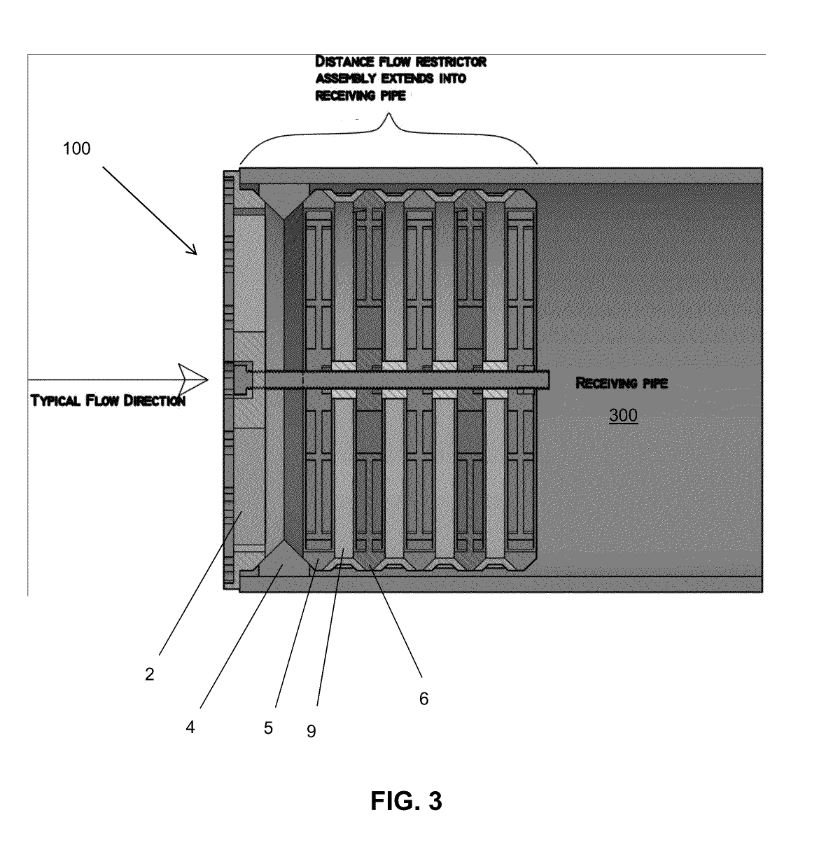

The restrictor assembly 100 can include a radially expanding gasket 4 to facilitate sealing of the assembly 100 in its particular environment, such as if the assembly is installed in a receiving pipe 300 as shown in FIG. 3. The gasket 4 can be used to frictionally engage the inside of the pipe 300 and fix the flow restrictor assembly 100 in place. In this exemplary environment, the restrictor assembly 100 is substantially recessed into the receiving pipe 300 and the gasket 4 can expand radially outwardly to seal the assembly against the inner surface of the receiving pipe when the assembly is tightened as will be explained later herein. In one embodiment, the gasket 4 can be formed of rubber, although other materials capable of providing the desired seal can also be utilized. The particular type of gasket 4, including the size, shape and/or type of material(s) can be selected based on a number of factors, including one or more of flow velocity, pressure, temperature, types of fluid and/or debris, types of environments, cost, and so forth. In this exemplary embodiment, a single gasket 4 is shown that is positioned abutting a rear face of the support frame of the restrictor assembly 100. However, the exemplary embodiments can include other numbers and/or positions of the gaskets 4, including utilizing different types of gaskets at different locations of the restrictor assembly 100. In one embodiment, the support frame 2 can include a tapered, beveled or angled edge 910 (shown in FIG. 9) that abuts against a corresponding tapered, beveled or angled edge 1110 (shown in FIG. 11) of the gasket 4 to facilitate positioning and sealing the gasket with the support frame.

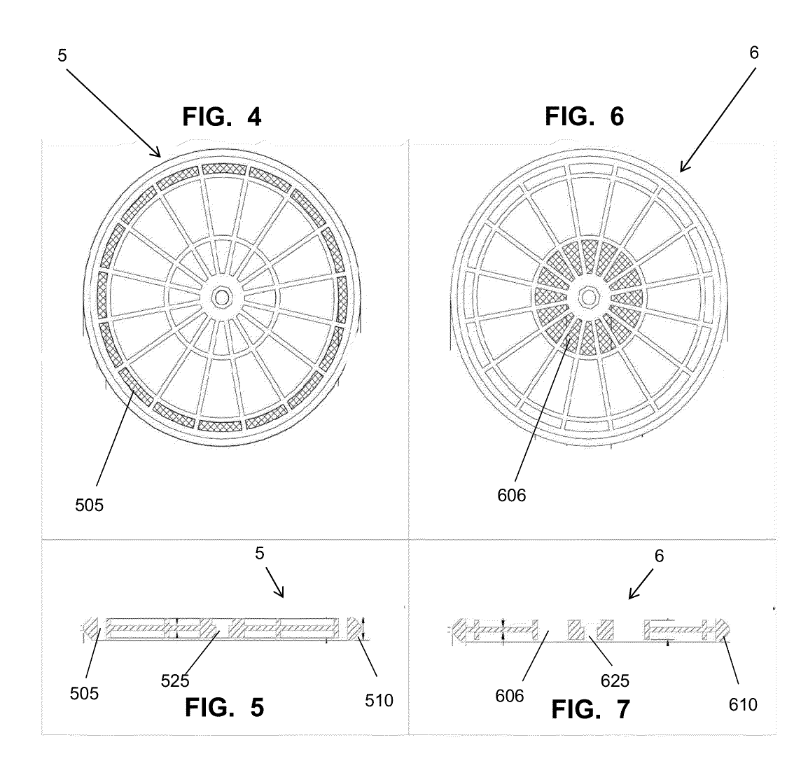

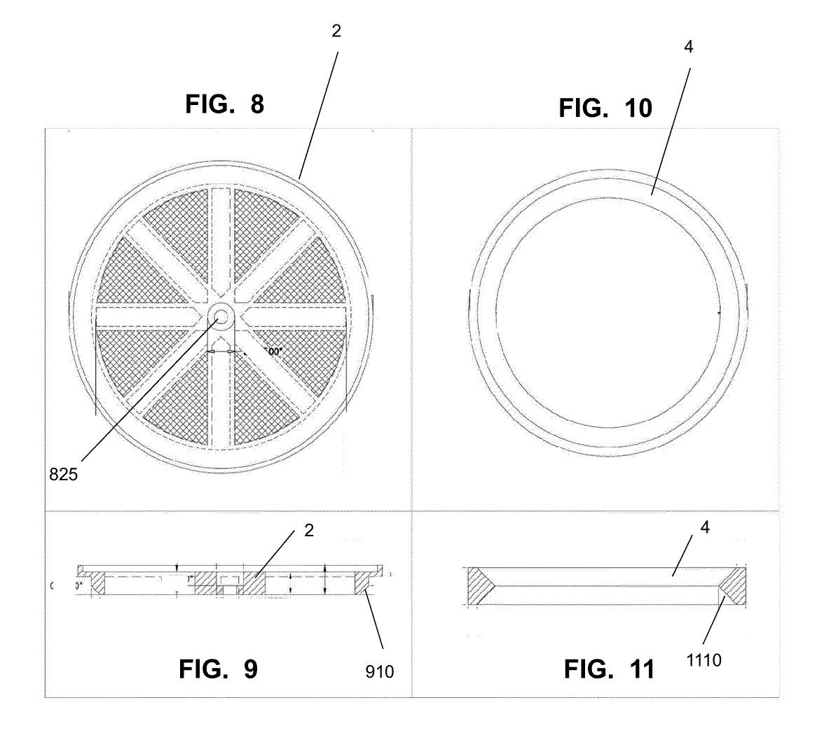

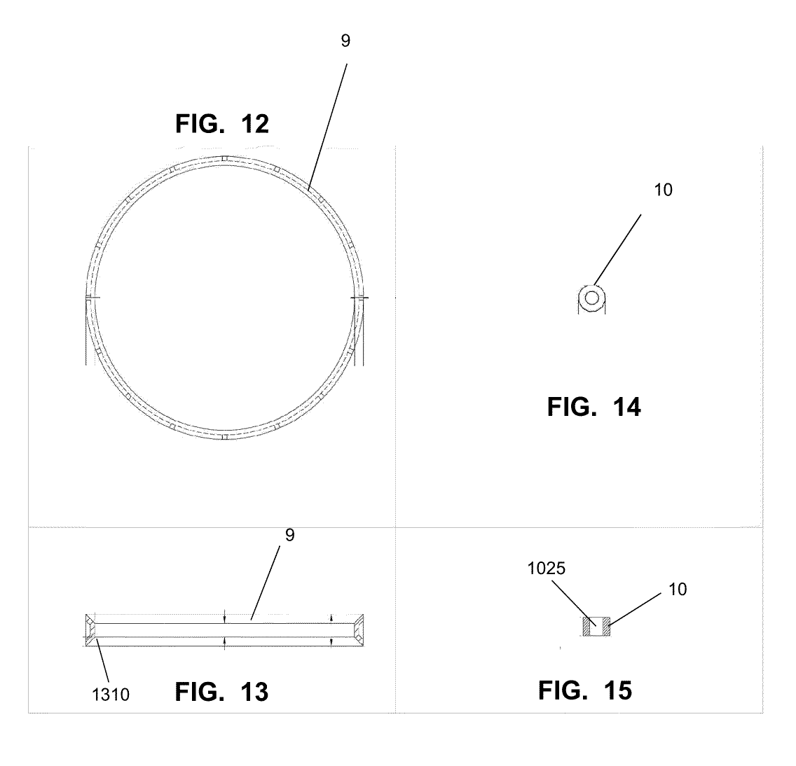

The restrictor assembly 100 can include a series of restrictor plates that are utilized for controlling the flow of the fluid through the assembly. Referring additionally to FIGS. 4-15, in one embodiment, the assembly 100 can include first plates 5 with one or more first openings 505 and second plates 6 with one or more second openings 606. In the illustrations of FIGS. 4 and 6, first and second openings 505, 606 are represented with cross-hatched areas. In this example, the first and second openings 505, 606 are a series of openings that form non-contiguous rings which are concentrically aligned with each other along respective outer and inner portions of the first and second plates 5, 6. By offsetting the first and second openings 505, 606 in pairs of adjacent plates 5, 6, the assembly can cause a change in the flow path from a linear path straight through the openings to a non-linear flow path. This change in the flow path can restrict the flow of fluid through the assembly 100. The use of plates having offset openings, such as annular openings that alternate between the perimeter and the interior of the plate on each subsequent plate, can enable the mechanism for flow restriction through repeated, rapid expansion and contraction of the flow between plates which results in significant energy losses. Other features of the plates 5, 6 and/or the assembly 100 can also be utilized to facilitate the flow restriction process, including one or more of the size and/or shape of the openings, the size of the spacing between plates, the size or the shape of the plates, and so forth. This exemplary embodiment utilizes a series of openings 505, 606 that form the non-contiguous rings. However, the assembly 100 can utilize plates having various openings including the size, shape and/or configurations of the openings which can be selected based on a number of factors, including one or more of flow velocity, pressure, temperature, types of fluid and/or debris, types of environments, cost, and so forth. The exemplary embodiment illustrates the use of concentric rings, but the exemplary embodiment can also utilize non-concentric rings that are contiguous and/or non-contiguous.

This exemplary embodiment illustrates the use of three first plates 5 that are positioned with two second plates 6 in an alternating fashion. The exemplary embodiments can include any number of restrictor plates that are alternating, partially alternating and/or non-alternating. The exemplary embodiments can also utilize any number of types of restrictor plates such as a series of the same plates or a series of three or more different plates. The restrictor plates can differ based on any of the features described herein, including the size, shape and/or configurations of the openings, as well as based on the size and/or shape of the plates.

A connector 7 can be utilized to assemble and tighten the various components of the assembly 100. The connector 7 can be any structure or combination of structure that can tighten the multiple components of the assembly 100 and enable a sealing connection between the assembly and the particular environment (e.g., the receiving pipe 300). For example, the connector 7 can be a central bolt that passes through a center hole 825 (e.g., a hole having a smooth or non-threaded surface to facilitate the assembly process) in the support frame 2 to hold the flow restrictor together and, when tightened with a recessed nut 8, causes the stack of plates 5, 6 to compress the rubber gasket 4 between the upstream-most plate and the rigid support frame 2. As a result, the rubber gasket 4 can be expanded and can contact the inner-wall of the receiving pipe 300. While the nut 8 is shown (e.g., FIG. 2) as a recessed component, one or more of the exemplary embodiments can include the nut not being recessed into the assembly 100.

In this exemplary embodiment, a single central bolt 7 and nut 8 are illustrated that pass through central openings in the various parts. However, in one or more of the exemplary embodiments, the connector 7 can be one or more other components and/or can utilize different connection techniques. For example, the connector 7 can be a group of connectors that are used with or without a central connector, such as having a plurality of equidistantly spaced bolts along a perimeter of the assembly 100. In another embodiment, the one or more bolts 7 can be secured directly into threads formed in one or more of the other components of the assembly. For instance, the final restriction plate in the series of plates can include threaded holes formed therein for securing the bolt therein while the other plates and other components have non-threaded opening for passing the bolt(s) therethrough. In another example, an end ring can be utilized which is positioned on the opposite side of the assembly 100 as the support frame 2 so that the bolt(s) 7 can be secured through the support frame and various components including the series of plates, and then secured into threads in the end ring or through a hole in the end ring utilizing nut 8. In one embodiment, the connector 7 can be a non-threaded connector, such as a rod with a cotter pin where the rod passes through the holes in the various components of the assembly 100 and the cotter pin fits through a hole in the rod. In another embodiment, the connector 7 can utilize a ratchet connector or fastener where each of the components of the assembly 100 can be pushed onto the ratchet (e.g., a central ratchet rod) fastener. Various other connection structure and/or techniques can be utilized for assembling the restrictor assembly 100 which can be selected based on a number of factors, including one or more of flow velocity, pressure, temperature, types of fluid and/or debris, types of environments, cost, and so forth. In one embodiment, the center holes 525, 625 in the plates 5, 6 can be non-threaded to facilitate sliding the connector 7 (e.g., a center bolt) therethrough. Although, the exemplary embodiment can include threads along one or more of these components and/or threads along the center hole 825. In one embodiment, the center holes 525, 626 can include two different inner diameters where the first inner diameter is large enough for allowing the connector 7 (e.g., a bolt) to pass therethrough, and where the second inner diameter is larger than the first inner diameter and allows the nut 8 to be positioned therein in a recessed fashion. In one embodiment, each of the restrictor plates can include the first and second inner diameter center holes so that the plates 5, 6 or other plates being utilized can be positioned in different orders. However, one or more of the exemplary embodiments can also include only one of the restrictor plates including the larger second diameter to accept the nut 8 so that this selected plate is the last plate in the series of plates.

In one embodiment, the restrictor assembly 100 can include one or more annular spacing rings 9 that are positioned between adjacent restrictor plates (e.g., between plates 5, 6) to prevent leakage around the exterior of the plates and/or to provide spacing between the plates. The particular size, shape, number, configuration and/or material of the spacing rings 9 can vary and can be based on a number of factors, including one or more of the size and/or shape of the abutting plates, flow velocity, pressure, temperature, types of fluid and/or debris, types of environments, cost, and so forth. In this exemplary embodiment, the spacing rings 9 are illustrated as separate structures that are positioned between each of the adjacent plates and have edges 1310 that correspond to the surfaces of the plates, such as tapered, beveled or angled edges 510, 610 of plates 5, 6 to facilitate the positioning and sealing of the plates with the spacing rings.

In one embodiment, the restrictor assembly 100 can utilize cylindrical spacers 10 to maintain a fixed spacing between adjacent plates (e.g., to enable desired discharge characteristics) and/or to facilitate the assembly of the various plates and/or spacing rings 9. The particular size, shape, number, configuration and/or material of the cylindrical spacers 9 can vary and can be based on a number of factors, including one or more of the size and/or shape of the abutting plates, flow velocity, pressure, temperature, types of fluid and/or debris, types of environments, cost, and so forth. In this exemplary embodiment, the cylindrical spacers 10 are separate structures that are positioned between each of the adjacent plates. In one embodiment, the center holes 1025 in the spacers 10 can be non-threaded to facilitate sliding the connector 7 (e.g., a center bolt) therethrough. Although, the exemplary embodiment can include threads on these components.

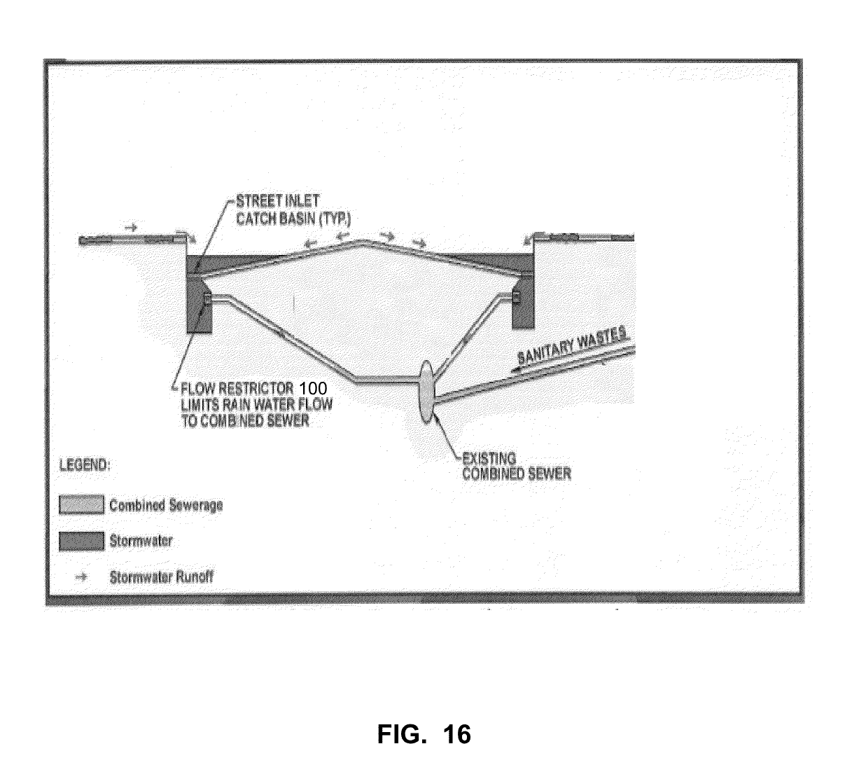

The restrictor assembly 100 can be utilized in numerous environments, including sewer systems, drainage systems, marine craft flow systems, as well as any system in which it is desired to restrict flow of a fluid. In one exemplary embodiment shown in FIG. 16, the restrictor assembly 100 is installed in a sewer system.

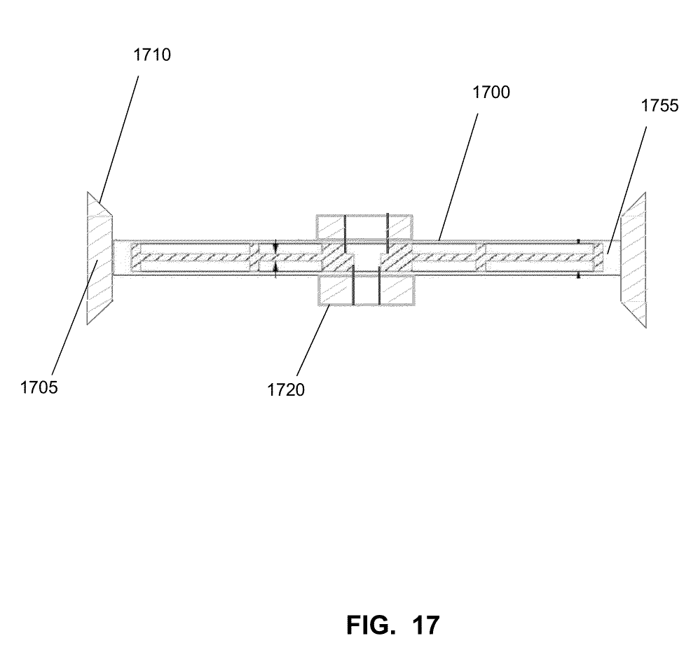

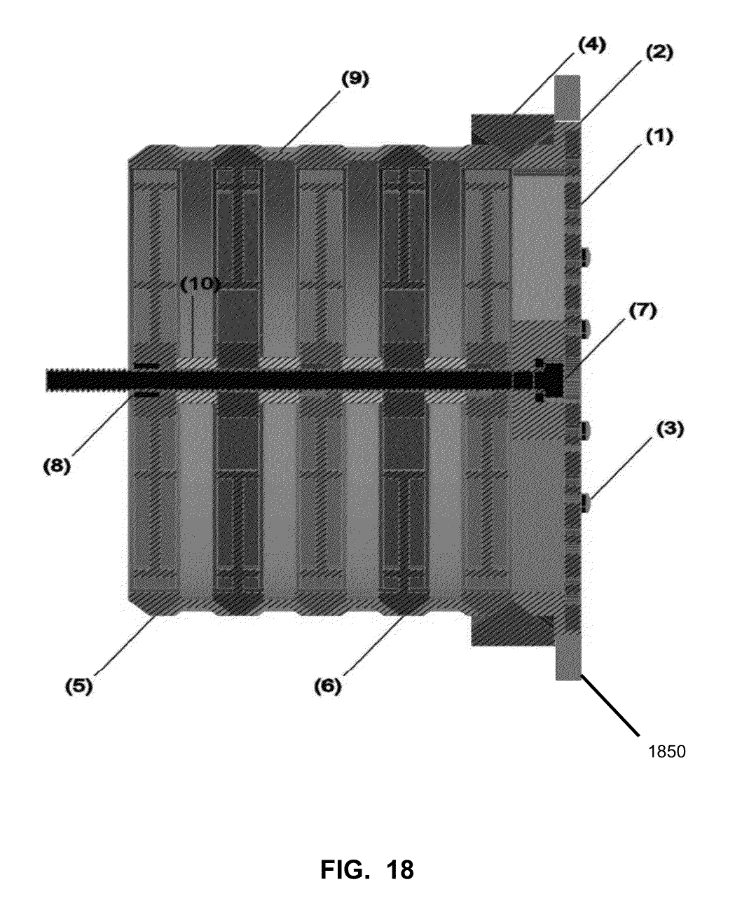

In one embodiment, one or more spacing structures can be integrally formed with one or more of the restrictor plates, such as shown in FIG. 17. The particular plates that include the spacing structure(s) can vary. For example, tapered edges 1710 can be formed along the outer sealing walls 1705 of the plate 1700. In another example, spacer 1720 can be integrally formed along the inner portion of the plate 1700. Plate 1700 can be positioned adjacent to other plates that do not have these spacing structures. One or more of the exemplary embodiments can include one or more spacing structures integrally formed with other components of the restrictor assembly 100, such as the support frame 2. In the illustrated body, openings 1755 are shown along an outer portion of the plate 1700, but the exemplary embodiments can include plates with openings at other locations and that include the spacing structure(s).

In one or more embodiments, the spacing between the series of plates (e.g., plates 5, 6) can be adjustable by exchanging out different spacing components. For instance, a user can be provided access to sets of cylindrical spacers 10, spacing rings 9 and/or restrictor plates with integrated spacing structure (e.g., walls 1705, edges 1710 and/or spacers 1720) with different dimensions so the user can adjust the spacing between plates based on the particular components that are selected and assembled in the assembly 100.

In one or more of the exemplary embodiments of restrictor assembly 100, restriction of flow can be achieved through a number of perforated and restrictor plates that are spaced apart, such as by spacing structure, one or more spacing rings, one or more rubber gaskets, and/or one or more cylindrical spacers. The exemplary assembly 100 can provide a modular design so that the number and/or type of restrictor plates can be adjusted to achieve different flow characteristics. In one embodiment, the spacing rings 9 can be made of a material that allows for compression and expansion to provide sealing for the assembly 100.

In one embodiment, a kit can be provided that includes the various components so that a user can select which of the components are to be used in the assembly, such as choosing the number of plates 5 and the number of plates 6 that are to be used. In another embodiment, the user can select the order of the plates, such as in an alternating fashion, in a partially alternating fashion or in a non-alternating fashion. In yet another embodiment, information, instructions and/or guidance can be provided to the user to indicate the flow characteristics that will result from the particular configuration of the plates, including the particular plates being utilized and/or the particular order of the plates. For instance, the user can be informed that utilizing three plates 5 and two plates 6 in an alternating fashion where one of the plates 5 is the most upstream plate results in particular flow characteristics. These characteristics can be described in a number of different ways, such as one or more of velocity, pressure, percentage of expected change, and so forth. This information can also be provided in accordance with particular environments, such as based on one or more of fluid types, temperatures, entrance velocities, entrance pressures, and so forth. The information can also be based on selection of various components of the assembly 100, such as spacers 10 and/or spacing rings 9 to adjust spacing between the plates.

The particular material utilized for one or more of these materials can vary based on a number of factors, including one or more of the environment type, temperature, type of fluid, pressure, velocity, debris, and so forth. In one embodiment, polypropylene and/or neoprene rubber can be utilized for one or more of the components or portions thereof For example, all components can be made from polypropylene except the radially expanding gasket 4 which can be made from neoprene rubber, the central bolt 7 and nut 8 which can be made from stainless steel, and the screws 3 that are used to affix the filter 1 (e.g., a perforated plate) to the support frame 2 where the screws can also be made from stainless steel. Utilizing these materials can provide for a useful life of 25-30 years under normal operations in an environment in a drainage or sewer system environment. However, in the event that a portion of the restrictor assembly 100 becomes damaged, it will not be necessary to replace the entire assembly. The modularity of assembly 100 makes it possible to replace only the damaged element, creating the potential for substantial long-term maintenance cost savings. In one embodiment, the material selected can have a Shore A durometer reading of approximately 60 and a tensile strength not less than 3000 psi. Suitable alternative rubber formulations may include natural or silicone rubber.

As can be seen from the illustration in FIG. 3 where the restrictor assembly 100 has been installed in the receiving pipe 300, a portion of the support frame 2 can abut against the receiving pipe to prevent the assembly from being installed too deep into the receiving pipe. In this exemplary embodiment, the support frame 2 can have an outer diameter that is larger than the outer diameter of the plates 5, 6 and the spacing rings 9. However, one or more of the exemplary embodiments can include different dimensions for one or more of these components, including a support frame with an outer diameter that enables sliding the entire assembly 100 into the receiving pipe, such as where a desired installation includes the assembly being completely recessed into the receiving pipe 300. In one embodiment shown in FIG. 18, the support frame 2 can include an extended flange 1850 that enables additional support to abut the flange against the edge of a receiving pipe while the gasket 4 is positioned within the receiving pipe for facilitating a sealing connection between the restrictor assembly and the receiving pipe.

As can be seen from FIG. 3, due to its compact structure the whole assembly 100 fits almost entirely within the receiving pipe 300 with only a small portion (e.g., approximately ½ inch of the assembly—although other dimensions can be utilized) extending into the catchment or other portion of the environment. In one embodiment, the rest of the restrictor assembly 100 that includes the exemplary five plates can extend approximately 6 inches into the receiving pipe. Although other dimensions can also be utilized for the exemplary embodiments. As shown in FIGS. 1 and 2 in one embodiment, the restrictor assembly 100 includes a series of stacked plates, rings, spacers, support frame and gasket, with a single bolt providing means of installation. The restrictor assembly 100 can be loosely assembled outside of the receiving pipe 300. The restrictor assembly 100 can then be inserted until the back of the rigid support frame 2 is flush with the inlet of the sewer pipe. A socket (e.g., a 9/16 inch—although other sizes can be used depending on the connector size) can then be passed through the centrally-located hole in the filter 1 (e.g., a perforated plate) and seated on the head of the stainless steel cap screw/bolt (e.g., a ⅜ inch—although other sizes can be used). As the bolt 7 is tightened, the components of the entire restrictor assembly 100 can be pulled towards the support frame 2 causing the gasket 4 to compress between the support frame 2 and the upstream-most restrictor plate 5. In conjunction with the compression, the tapered sides of the support frame 2 and restrictor plate 5 cause the rubber gasket 4 to expand radially until it engages the inside of the receiving pipe 300, which can result in a water-tight, slip-resistant seal. In one embodiment, the restrictor assembly 100 can remain in place for 10-ft of pressure or more utilizing this sealing connection.

In one or more embodiments, the simplicity of the modular structure of assembly 100 can reduce maintenance requirements. The restrictor assembly 100 can protrude out of the receiving pipe 300 by a small amount (e.g., ½ inch) thus mitigating any potential for debris to snag on the inlet of the assembly. In addition, the presence of a relatively high porosity filter 1 (e.g., on the order of 40% when utilizing a perforated plate) at the entrance to the restrictor assembly acts to screen out any large debris that would otherwise enter the restrictor assembly and clog it internally. In the unlikely event that the assembly 100 becomes clogged, removing the debris is simply a matter of removing the restrictor assembly 100 from the receiving pipe 300, loosening the bolt 7 enough to allow free motion between the individual plates 5, 6, and removing the debris.

In one embodiment, using the restrictor plate 5 with the openings 505 at the perimeter of the plate or disk as the upstream-most restrictor plate of the assembly 100 (e.g., after the filter 1 and gasket 4), flow is drawn into the restrictor assembly from a de-centralized location, mitigating the possibility of a single piece of debris causing any significant clogging of the restrictor assembly intake. The de-centralization of the inflow can also result in decreased entrance velocities, minimizing the tendency for leaves, plastic bags, and so forth to be sucked up against the intake and clog the assembly 100. In a drainage or sewer system, this intake feature allows any debris in the catch basin (e.g., manhole) to freely move around in the basin, rising and falling with the water level in the basin, and not become an inhibiting factor to the flow in the restrictor assembly.

In the event that one of the plates 5, 6 becomes damaged or otherwise un-usable, the modularity of the restrictor assembly 100 allows for the replacement of the damaged piece only, resulting in a potentially substantial cost savings versus replacing the entire restrictor assembly.

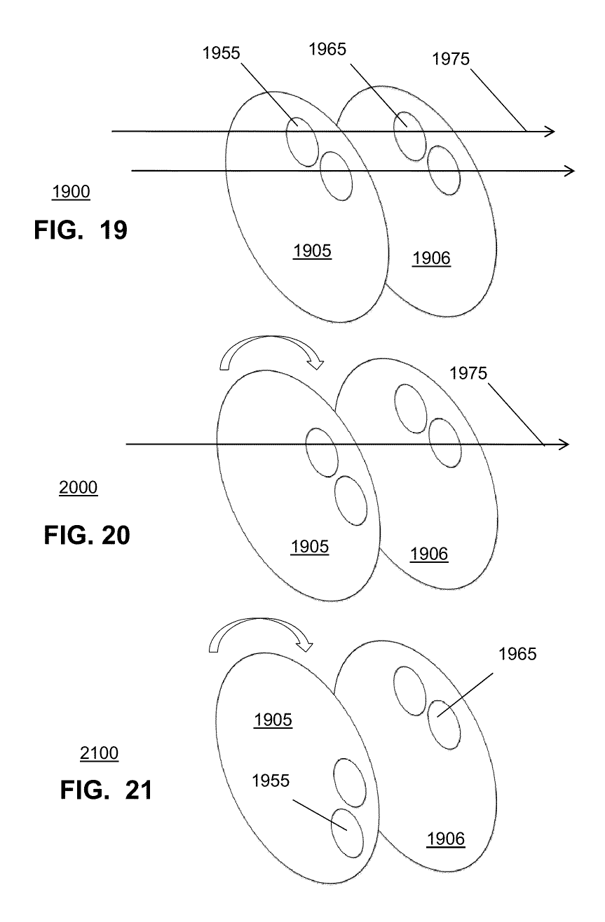

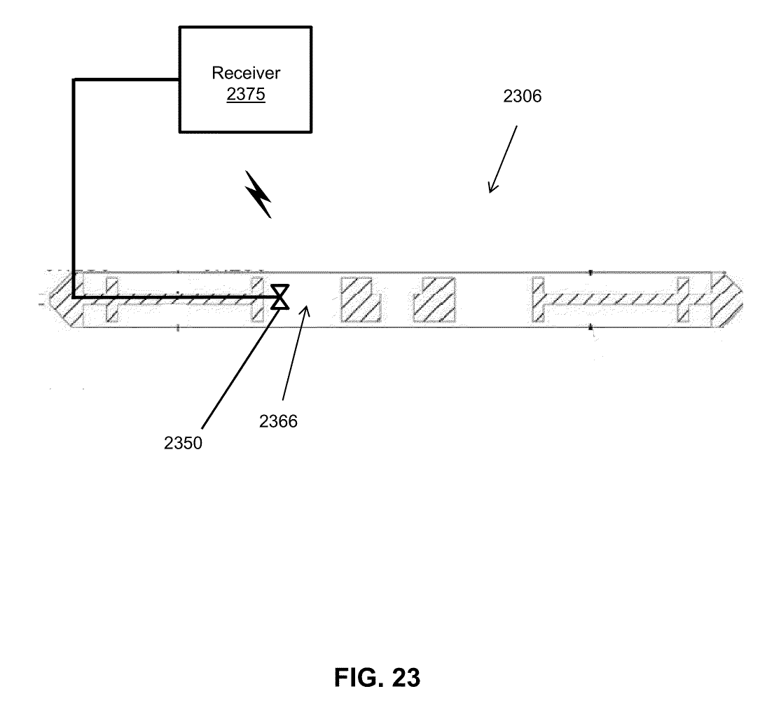

Referring additionally to FIGS. 19-21, in one embodiment, the flow characteristics of the assembly 100 can be adjusted based on the selected orientation of openings 1955, 1965 through the series of plates 1905, 1906 with respect to each other. For example orientation 1900 illustrates the pair of plates 1905, 1906 with openings 1955, 1965 that are substantially aligned as represented by the two arrows 1975. Orientation 2000 illustrates the pair of plates 1905, 1906 with only one of the openings 1955 being substantially aligned with the other opening 1965 as represented by the single arrow 1975. Orientation 2100 illustrates the pair of plates 1905, 1906 with none of the openings 1955 being substantially aligned with the other openings 1965. The orientation can be adjusted by rotating one or both of the plates 1905. 1905 to achieve a desired orientation that provides the desired flow characteristics. In one embodiment, the plates can have markings or other indicia for alignment at desired orientations that provide desired flow characteristics. While this exemplary embodiment shows only two plates having only two openings each that are positioned similarly for each plate, it should be understood that any number of plates having any number of openings that can be similarly positioned along the plates and/or can be positioned along different portions of the plate can be utilized with one or more of the exemplary embodiments. In one or more embodiments, the rotation of one or more restrictor plates with respect to each other can be performed manually such as at the time of assembly, which may or may not include the assistance of markings as guidance for the desired orientation. In one or more embodiments, the rotation of one or more restrictor plates with respect to each other can be performed automatically utilizing a power source, such as a motor, actuator, servo-motor or other mechanism which enables rotation of the plate(s). The particular type of power source can vary based on a number of factors, including one or more of flow velocity, pressure, temperature, types of fluid and/or debris, types of environments, cost, and so forth. The power source can be coupled or otherwise connected with the assembly 100 in various ways, including internally of the assembly or externally of the assembly, such as being connected to or otherwise coupled with a last restrictor plate in the series of plates. In one embodiment, one or more of the plates can include gears that mesh with gears on a motor which when actuated cause the plate(s) to rotate. The particular type of gears or other components utilized to translate the motion imparted by the motor to the desired orientation of the plate(s) can vary based on any of the factors or combination of factors described above. In one embodiment, the amount of orientation can be limited by structures or other devices that are independent of the motor, such as a stopper on one or more of the plates or on another structure of the assembly 100 that limits the amount of rotation of the plate(s) by the motor or other power source. In one embodiment, the power source, such as a motor, can be controlled after assembly of the restrictor assembly 100, such as through a user actuating the power source when the assembly is about to be inserted into the receiving pipe 300 or other environment. In another embodiment, the motor can be remotely controlled, such as through wired and/or wireless communication with a control device. The remote control communication can be performed in a number of different ways, including utilizing the communication techniques described later herein with respect to the data collection of FIG. 23.

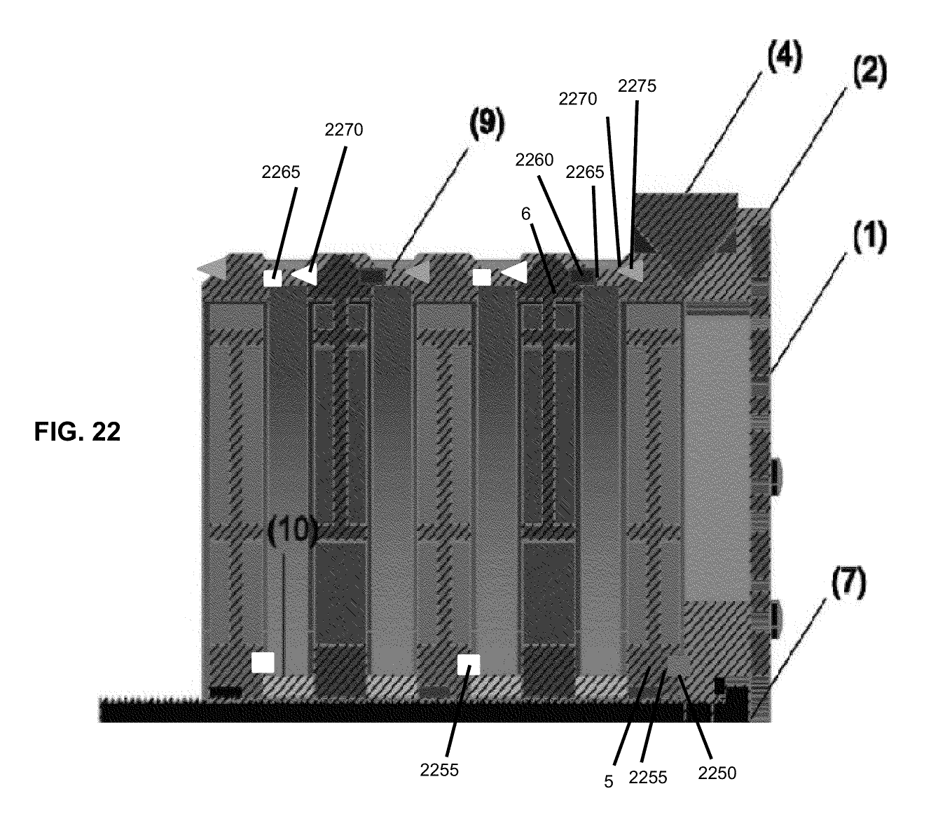

In one embodiment, keys can be utilized that dictate or otherwise control the positioning of the plates with respect to each other. Referring additionally to FIG. 22, in another exemplary embodiment, keys can be used so that the plates are arranged in a specific order in the assembly 100. For instance, the keys can be structure integrally formed in the components that mate with corresponding structure on the component that is to be placed adjacent thereto. As shown in one example, one or more keys 2250 can be formed on the support frame 2 that mate with one or more keys 2255 (e.g., a recess of the same shape and size) on plate 5 so that the assembly can be installed with the desired plate in the most-upstream position. In this embodiment, since plate 6 does not include the key 2255 it would not mate properly into the lead plate position. In one embodiment, other keys 2260, 2265, 2270 and/or 2275 can be used with one or more of the plates 5, 6 and/or the spacing rings 9 so that a desired configuration of the plates is utilized in the assembly 100. The keys can be of various shapes and sizes, and can be positive structure(s), such as a protrusion, and/or negative structure(s), such as a recess or gap. In the example of FIG. 22, the use of keys can enable the series of plates to be assembled in an alternating fashion with plate 5 being the lead plate. While this example utilizes keys to achieve desired configurations of plates in the series of plates, one or more of the exemplary embodiments can use only some keys (e.g., only to require a particular plate to be the lead plate) or can use no keys such that any configuration of plates can be used in the assembly 100.

One or more of the exemplary embodiments can include one or more measuring devices for collecting or otherwise obtaining data with respect to the assembly 100 and/or the fluid flow therethrough. In one embodiment shown in FIG. 23, one or more restrictor plates 2306 can be provided with a measuring device 2350 for measuring characteristics of the fluid flowing through the plate. For instance, the measuring device 2350 can be a sensor that is positioned in proximity to an opening 2366 in the plate to collect data with respect to the fluid flowing through the opening, including one or more of pressure data, velocity data, temperature data, and so forth. In this embodiment, the measuring device 2350 can be connected with a wall of the plate 2306 where the wall forms one of the openings 2366. It should be understood that plate 2306 is an exemplary measuring plate and other configurations of measuring plates can be utilized, including measuring plates with different opening sizes, opening shapes, numbers of openings and/or positions of openings. In one embodiment, the measuring plate 2306 that includes the measuring device 2350 can be of the same type as other plates that do not include the measuring device as well as different from yet other plates that also do not include the measuring device. The particular position of the plates in the series of plates can differ including being the last plate in the series so as to measure parameters associated with the exhausting of fluid from the assembly 100 and/or being the lead plate so as to measure parameters in proximity to the entrance of the assembly. In one embodiment, the measuring device can measure parameters associated with the assembly 100, such as stress on the plate 2350, flow discharge, leakage, and so forth.

The measuring device 2350 can be various types of devices, including electronic devices that are battery-operated and/or powered by an external source (e.g., an impeller or turbine rotated by the fluid flow). The measuring device 2350 can be a wireless device that transmits collected data to a receiver 2375 and/or can be a wired device that provides the data along a wired connection to the receiver. The data can be accessed to analyze the assembly 100 and determine various characteristics associated with the flow therethrough. For instance, where the environment is a sewer system, the receiver 2375 can be positioned above ground so that the measuring device 2350 can transmit (wirelessly and/or via hardwire connection) the collected data to the receiver for storage and the receiver can relay or otherwise provide access to the data for analysis.

### EXAMPLE

The discharge characteristics of an exemplary flow restrictor assembly were determined using a three-dimensional computational fluid dynamics model, FLOW-3D. Based on the FLOW-3D model results, a discharge rate of 4.9 l/s (0.173 cfs) was determined for the restrictor assembly at 5 ft of head and 4.4 l/s (0.155 cfs) at 4 ft.

FLOW-3D uses the finite-volume method to solve the Reynolds-Averaged Navier-Stokes (RANS) equations. The computational domain is subdivided into variable sized hexahedral cells along the primary Cartesian coordinates. For each cell, average values for the flow parameters (pressure and velocity) are computed at discrete times using a staggered grid technique (Versteeg and Malalasekera 1995). The renormalization group (RNG) turbulence model, as outlined by Yakot and Nakayama (1986), was used for turbulence closure. To represent obstacles FLOW-3D uses the Fractional Area/Volume Obstacle Representation (FAVOR) method, which is outlined by Hirt and Sicilian (1985) and Hirt (1992). The FAVOR method is a porosity technique with a value of zero within obstacles and one for cells without the obstacles. Cells only partially filled with an obstacle have a value between zero and 1, based on the percent volume that is solid.

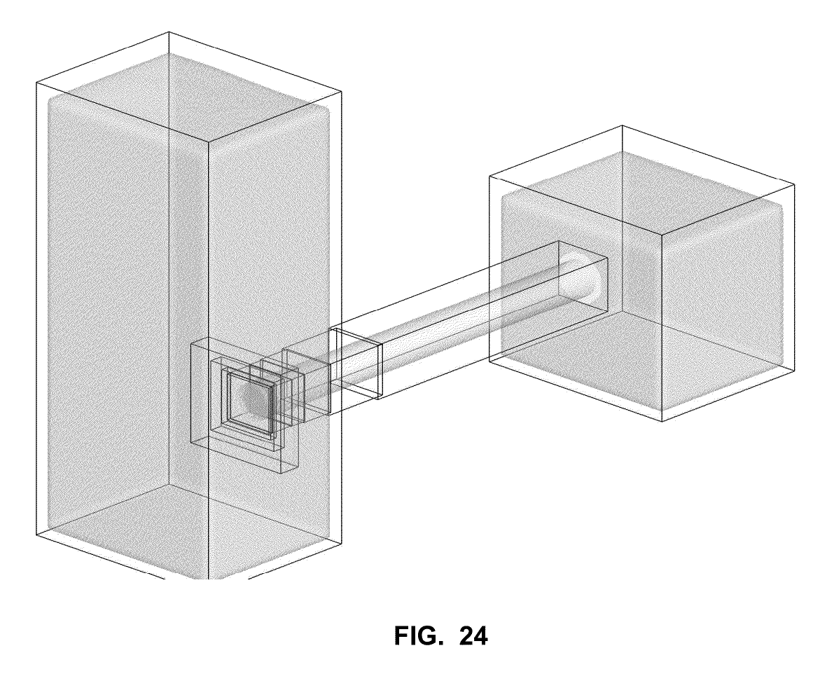

In order to determine the discharge characteristics of the exemplary flow restrictor assembly 100, the CFD models were implemented in the following manner. Two reservoirs 3 feet long, by 4 feet wide, by 10 feet high were connected by way of an eight inch conduit as shown in FIG. 24. The conduit (representative of the receiving pipe) measured 80 inches in length (10 times the pipe diameter) and was centered three feet from the bottom of the reservoirs. The inverted trap configuration present in a typical City of Chicago sewer catchment means that the receiving pipe should always be flowing full at the location of the pipe inlet—therefore the water-surface elevation in the downstream reservoir was maintained at an elevation 2 feet above the centerline of the receiving pipe. For the two flow conditions examined, corresponding to a pressure differential of 4 and 5 feet, the water-surface elevation in the upstream reservoir was maintained at 6 and 7 feet above the centerline of the receiving pipe, respectively.

A multi-block gridding method was used in order to speed convergence of the numerical model, with high spatial-resolution blocks in the vicinity of the flow restrictor (on the order 0.1 inch in each direction) where rapid variation in flow are expected, and lower resolution blocks in the body of the reservoirs and the 8-inch conduit (on the order of 1 inch in each direction). The computational domain including the nested computational block locations is shown in FIG. 24. A total of 1,600,000 computational cells were utilized for the current set of computations.

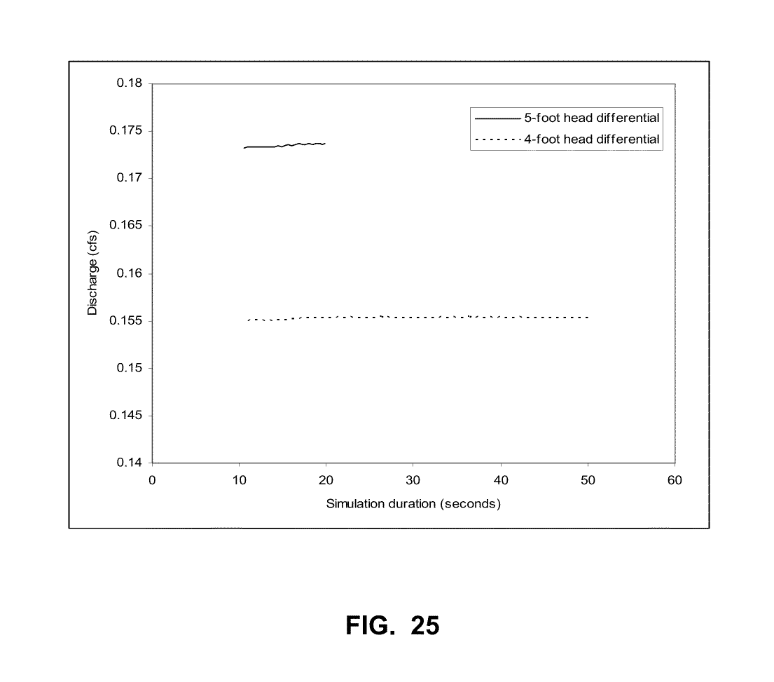

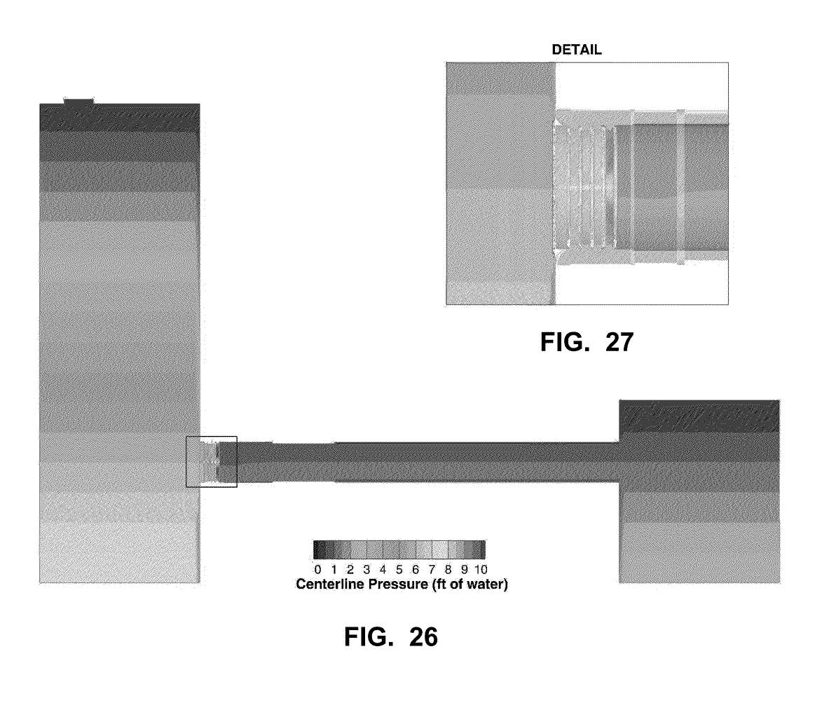

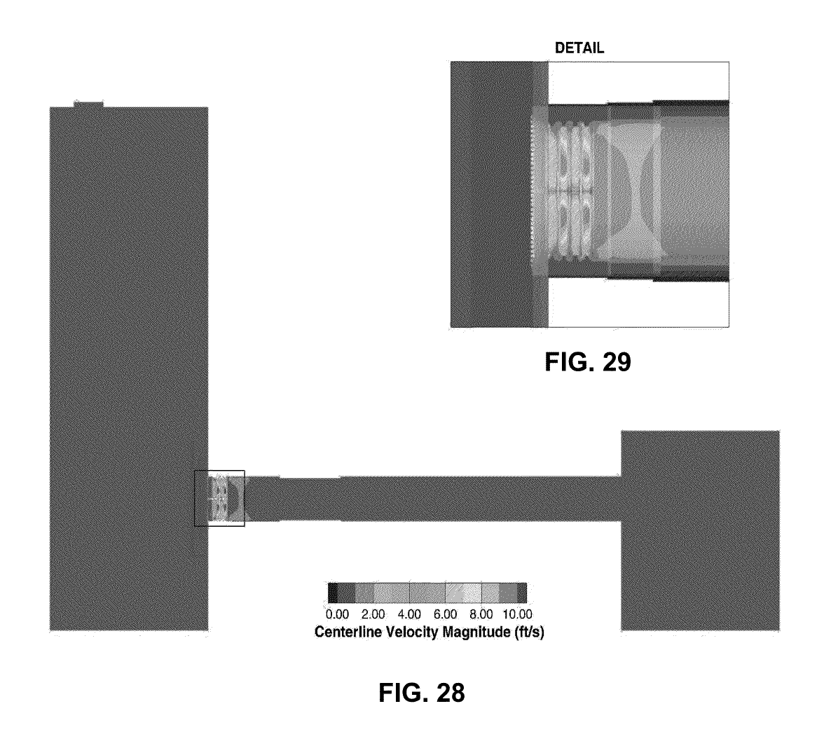

FIG. 25 presents a time series plot of the discharge calculated seven pipe diameters downstream of the flow restrictor. In each case, computations were re-started from a prior simulation at 10 seconds. The two runs took a different amount of time to reach numerical converge with respect to kinetic energy and turbulence parameters—this is the cause for the different total duration for the two simulations. FIGS. 26-29 present the pressure and velocity magnitude along a vertical plane located along the centerline of the pipe and reservoirs. These centerline pressure and velocity distributions were calculated for five feet of head. Results indicate flow velocities on the order of 0.5 ft/s immediately upstream of the flow restrictor, so that it is unlikely that a significant amount of debris will be attracted to the face of the restrictor assembly 100.

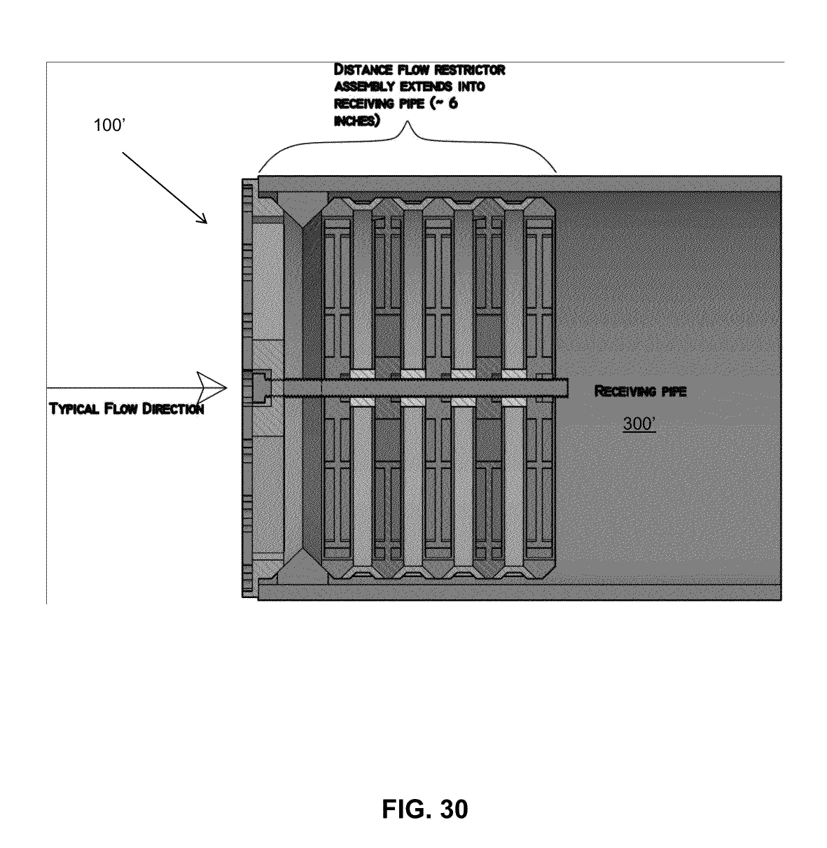

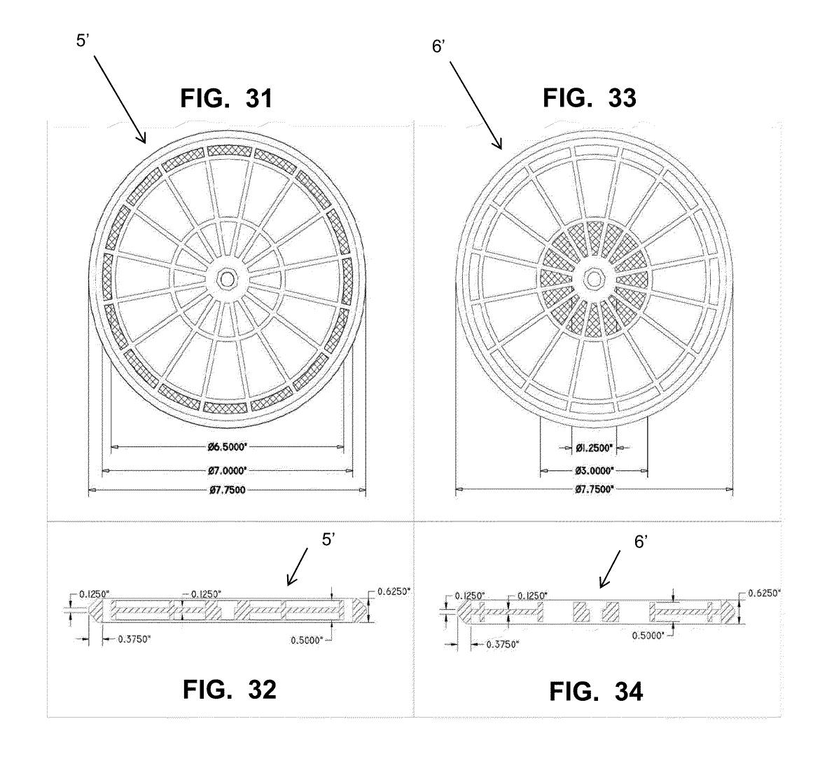

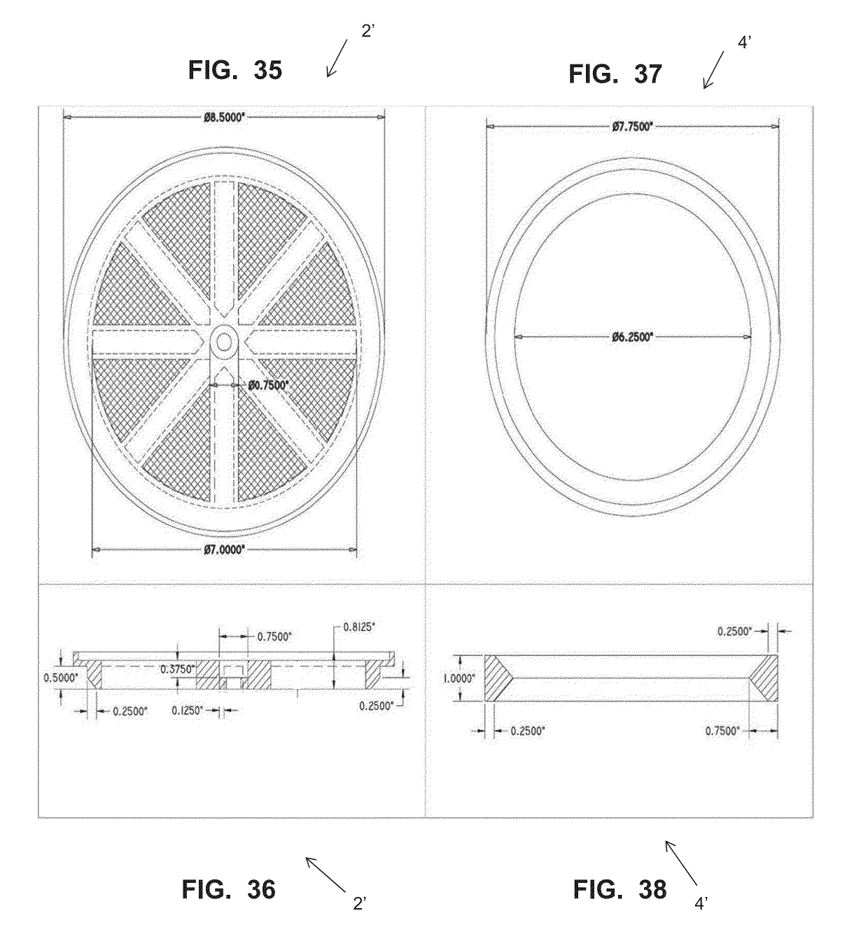

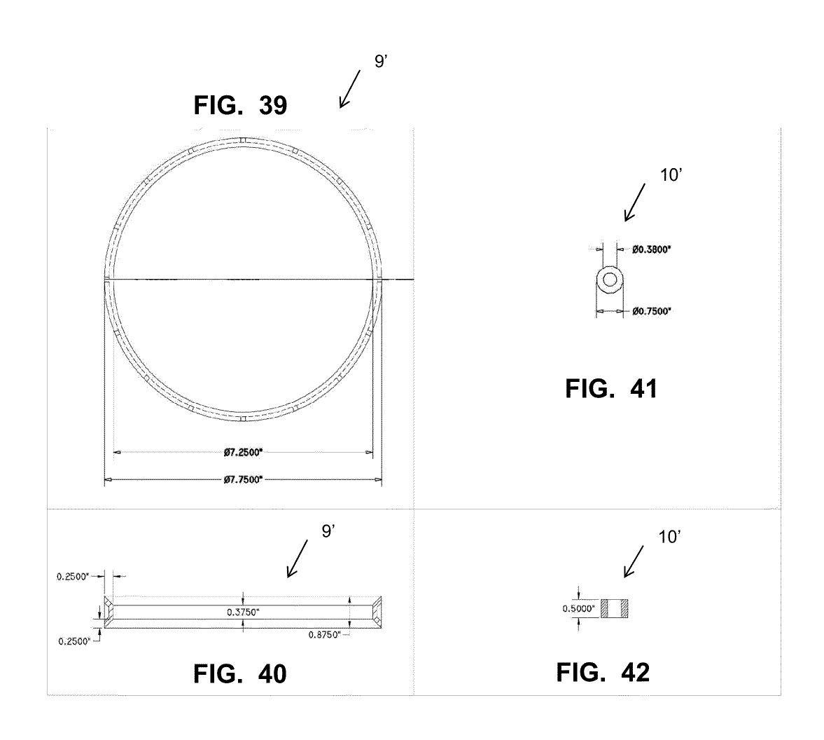

The exemplary assembly 100, including the dimensions, plates and configuration which were utilized for gathering the data of FIGS. 25-29, is illustrated in the various cross-sectional and plan views of the assembly and components in FIGS. 30-42 where the reference numerals are given a prime (e.g., assembly 100′) to indicate that the dimensions are exemplary for one embodiment and other dimensions can be utilized in other embodiments. While these dimension, shapes and configurations were utilized for gathering the above data, it should be understood that the dimensions, shapes and configurations, including the positioning, size and shape of the openings in the group of restrictor plates of the assembly can be varied based on a number of factors, including one or more of type of environment, type of fluid, expected debris, desired flow characteristics, pressure, temperature, velocity, turbulence, and so forth.

The modular nature of the flow restrictor assembly 100 has many benefits. In the unlikely event that the assembly becomes clogged, it is a simple matter to remove the assembly 100 and have quick, complete access to all of the components for cleaning. It is also possible to replace any component of the assembly 100 individually in the event that a piece becomes damaged, resulting in a substantial cost savings over non-modular systems that require replacement of the entire restrictor. Additionally, the modular nature of the assembly 100 makes it very simple and cost effective to alter the discharge characteristics of the flow restrictor assembly in a number of different ways, such as one or more of adding or removing restrictor plates from the flow restrictor assembly, adjusting an orientation of the restrictor plates, adjusting a spacing of the restrictor plates, and so forth.

In one or more embodiments, the restrictor assembly 100 can be used in drainage systems to control flow from various sources, such as controlling the amount of water going to the sewer tanks and the overflow onto streets. The exemplary embodiments can provide for tunable flow capacities, such as through adding or removing restrictor plates from the assembly 100 and/or through adjusting the orientation of the restrictor plates in the assembly. One or more of the exemplary embodiments can facilitate installation such as through partial assembly (e.g., loosely assembling the parts) and tightening the assembly once the restrictor assembly 100 has been positioned with respect to the pipe whose flow it is to control (e.g., partially being inserted into the end of a pipe). It should be understood that exemplary embodiments allow for the size of the assembly, the shape of the assembly, the order or configuration of the parts of the assembly, and/or the materials utilized for one or more of the parts of the assembly to be adjusted based on a number of factors, including the particular environment in which the restrictor assembly is utilized (e.g., a fixed facility system such as sewer drainage systems and other flow systems such as in a marine vessel) and/or the type of fluids passing through the restrictor assembly. The exemplary embodiments can also be utilized with other devices and/or other parts, including in addition to and/or in place of the one or more features described with respect to the exemplary embodiments.

From the foregoing descriptions, it would be evident to an artisan with ordinary skill in the art that the aforementioned embodiments can be modified, reduced, or enhanced without departing from the scope and spirit of the claims described below. For example, the restrictor plates can include channels or other structures to impart desired fluid flow characteristics including causing and/or reducing turbulence.

Other suitable modifications can be applied to the present disclosure. Accordingly, the reader is directed to the claims for a fuller understanding of the breadth and scope of the present disclosure.

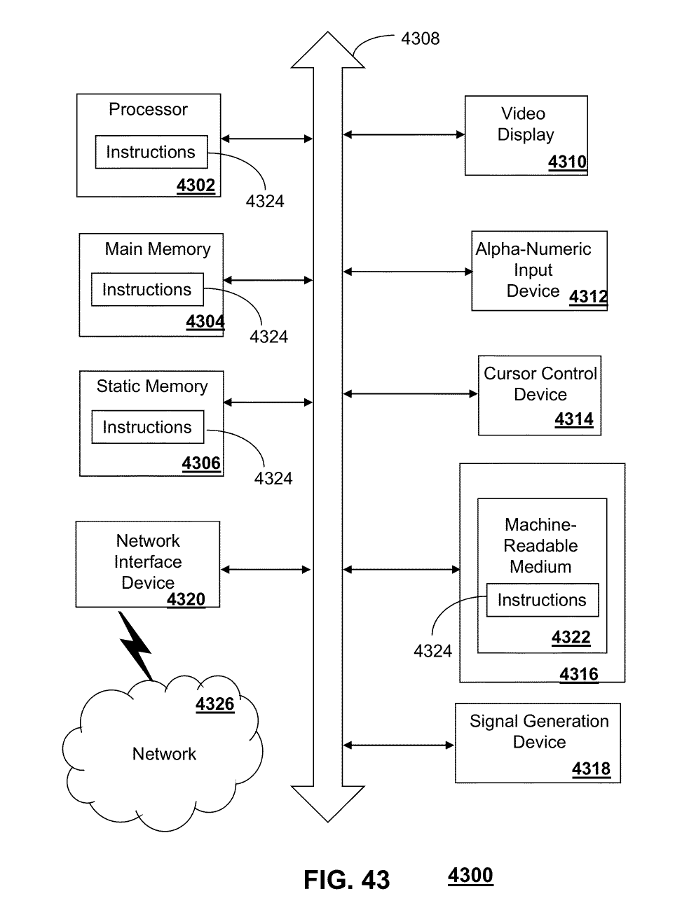

FIG. 43 depicts an exemplary diagrammatic representation of a machine in the form of a computer system 4300 within which a set of instructions, when executed, may cause the machine to perform any one or more of the methodologies discussed above. The machine can be part of or in communication with the measuring device 2350, a data collection device or receiver 2375 associated with the measuring device, a computing device that analyzes the collected data, and so forth. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video and/or data communication. Further, while a single machine is illustrated, the term “machine” shall also be taken to include any collection of machines that individually or jointly execute a set (or multiple sets) of instructions to perform any one or more of the methodologies discussed herein.

The computer system 4300 may include a processor 4302 (e.g., a central processing unit (CPU), a graphics processing unit (GPU, or both), a main memory 4304 and a static memory 4306, which communicate with each other via a bus 4308. The computer system 4300 may further include a video display unit 4310 (e.g., a liquid crystal display (LCD), a flat panel, a solid state display, or a cathode ray tube (CRT)). The computer system 4300 may include an input device 4312 (e.g., a keyboard), a cursor control device 4314 (e.g., a mouse), a disk drive unit 4316, a signal generation device 4318 (e.g., a speaker or remote control) and a network interface device 4320.

The disk drive unit 4316 may include a machine-readable medium 4322 on which is stored one or more sets of instructions (e.g., software 4324) embodying any one or more of the methodologies or functions described herein, including those methods illustrated above. The instructions 4324 may also reside, completely or at least partially, within the main memory 4304, the static memory 4306, and/or within the processor 4302 during execution thereof by the computer system 4300. The main memory 4304 and the processor 4302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 4324, or that which receives and executes instructions 4324 from a propagated signal so that a device connected to a network environment 4326 can send or receive voice, video and/or data, and to communicate over the network 4326 using the instructions 4324. The instructions 4324 may further be transmitted or received over a network 4326 via the network interface device 4320.

While the machine-readable medium 4322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored. The machine-readable medium can be a non-transitory medium.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. The terms “a”, “at least one” and “one or more” can include both single and multiple elements.

The Abstract of the Disclosure is provided allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus, comprising:
at least one first plate having at least one first opening;
at least one second plate having at least one second opening; and
a connector for coupling the at least one first plate and the at least one second plate, wherein the at least one first and second openings are offset to form a non-linear flow path for restricting flow of a fluid through the at least one first and second plates.

2. The apparatus of claim 1, wherein the at least one first plate is a plurality of first plates that each have the at least one first opening, and wherein the at least one second plate is a plurality of second plates that each have the at least one second opening.

3. The apparatus of claim 2, wherein the at least one first opening is a series of first openings positioned along an outer portion of each of the plurality of first plates to form a non-contiguous first ring, wherein the at least one second opening is a series of second openings positioned along an inner portion of each of the plurality of second plates to form a non-contiguous second ring, and wherein the non-contiguous first and second rings are concentric.

4. The apparatus of claim 3, further comprising a plurality of spacing rings, wherein pairs of first and second plates of the plurality of first and second plates are separated from each other by a spacing ring of the plurality of spacing rings.

5. The apparatus of claim 1, further comprising a gasket, wherein the gasket and the coupling of the at least one first and second plates provides a seal for flow of the fluid through the at least one first and second openings.

6. The apparatus of claim 5, comprising:
a filter; and
a support frame,
wherein the filter and the at least one first plate are coupled with the support frame by the connector,
wherein the at least one first plate and the at least one second plate are coupled together with a spacer ring therebetween,
wherein the at least one first opening of the at least one first plate is formed along an outer portion of the at least one first plate,
wherein the at least one second opening of the at least one second plate is formed along an inner portion of the at least one second plate, and
wherein a lead first plate of the at least one first plate is upstream of the at least one second plate.

7. The apparatus of claim 6, wherein the support frame comprises an outer flange having an outer diameter that is greater than outer diameters of the at least one first and second plates and the spacer ring, and wherein the gasket abuts against the outer flange.

8. The apparatus of claim 6, wherein the support frame comprises a front face having a seat for positioning the filter therein whereby the filter is substantially flush with the front face.

9. The apparatus of claim 6, wherein at least a portion of the at least one first and second plates include keys having structures that prevent positioning of the at least one first and second plates in an improper order.

10. The apparatus of claim 1, wherein the connector comprises a central bolt that passes through center openings in each of the at least one first and second plates.

11. The apparatus of claim 1, wherein the at least one first opening of the at least one first plate is a plurality of openings that are formed in an asymmetrical pattern.

12. The apparatus of claim 1, wherein the at least one first and second openings are formed in patterns that enable controlling a flow rate of the fluid therethrough based on an orientation of the at least one first plate relative to the at least one second plate.

13. The apparatus of claim 1, wherein pairs of the at least one first and second plates are separated from each other by a spacing ring, and further comprising a measuring device for collecting measurements with respect to the fluid.

14. The apparatus of claim 13, wherein the measuring device is connected to one of the at least one first plate, the at least one second plate or the spacing ring, and wherein the measuring device wirelessly transmits data to a remote receiver.

15. A kit capable of having at least a portion thereof assembled to form a restrictor assembly, the kit comprising:
a support structure;
a group of plates including a plurality of first plates and a plurality of second plates, wherein each first plate of the plurality of first plates has at least one first opening, and wherein each second plate of the plurality of second plates has at least one second opening; and
a connector for coupling the support structure with at least one first plate of the plurality of first plates and with at least one second plate of the plurality of second plates to assemble the restrictor assembly, wherein the at least one first opening and the at least one second opening have a size, shape and position that cause a restriction of flow of a fluid through the restrictor assembly when assembled.

16. The kit of claim 15, wherein the support structure includes a plurality of spacer rings, a filter, a support frame, and a gasket that abuts against the support frame when the restrictor assembly is assembled,
wherein pairs of first and second plates of the plurality of first and second plates are separated from each other by a spacing ring of the plurality of spacing rings when the restrictor assembly is assembled,
wherein the filter and a lead first plate of the plurality of first plates are coupled with the support frame by the connector when the restrictor assembly is assembled,
wherein the at least one first opening is formed along an outer portion of each of the plurality of first plates,
wherein the at least one second opening is formed along an inner portion of each of the plurality of second plates, and
wherein the lead first plate of the plurality of first plates is upstream of each of the at least one second plate of the plurality of second plates when the restrictor assembly is assembled.

17. The kit of claim 16, wherein one plate of the group of plates includes a measuring device, wherein the measuring device is configured for collecting measurements with respect to the fluid when the restrictor assembly is assembled and includes the one plate.

18. The kit of claim 15, wherein at least a portion of the group of plates includes keys having structures that prevent positioning in an improper order when the restrictor assembly is assembled.

19. An apparatus comprising:
a plurality of plates including a first plate and a second plate, wherein the first plate has at least one first opening, and wherein the second plate has at least one second opening;
a connector for coupling the plurality of plates; and
a spacing structure to maintain a desired spacing between the at least one first opening and the at least one second opening when the plurality of plates is coupled by the connector,
wherein the at least one first and second openings have a size, shape and position that restrict flow of a fluid through the apparatus.

20. The apparatus of claim 19, wherein the spacing structure is integrally formed with at least one of the first or second plates, and wherein at least one of the size, shape or position of the at least one first and second openings causes a flow path of the fluid to be non-linear through the apparatus.
